(19) United States
(12) Patent Application Publication
(10) Pub. No.: US 2019/0185264 A1
(43) Pub. Date: Jun. 20, 2019

(54) TRASH CAN LID FASTENER

(71) Applicant: Robert A. Azzaro, Pacifica, CA (US)

(72) Inventor: Robert A. Azzaro, Pacifica, CA (US)

(21) Appl. No.: 16/220,637

(22) Filed: Dec. 14, 2018

Related U.S. Application Data
(60) Provisional application No. 62/599,177, filed on Dec. 15, 2017.

(51) Int. Cl. B65F 1/16

(52) U.S. Cl. CPC B65F 1/1615

(57) ABSTRACT

A trash can lid fastener. The trash can lid fastener is designed to secure a trash can lid to a trash can. The trash can lid has a bracket with a first arm and a second arm. The second arm is orthogonally affixed to the first arm, forming a shape that can secure over a top end of a trash can with a lid. At least one first arm fastener is designed to secure the first arm to the side of the trash can and the at least one second arm fastener is designed to movably secure the second arm to the lid of the trash can. When engaged, the trash can lid is secured to the trash can by the trash can lid fastener.

### CROSS REFERENCE TO RELATED APPLICATIONS

This application claims the benefit of U.S. Provisional Application No. 62/599,177 filed on Dec. 15, 2017. The above identified patent application is herein incorporated by reference in its entirety to provide continuity of disclosure.

### BACKGROUND OF THE INVENTION

The present invention relates to a trash can lid fastener. Specifically, a trash can lid fastener configured to be both easy to use and adjustable, such as to be mountable upon any model of trash can.

When people produce refuse, they must have a process for disposed of that refuse. Commonly, individuals will utilize a trash can, or similar apparatus, to store and dispose of refuse. Many individuals, however, have difficulty keeping trash can lids secured upon trash cans. Trash can lids can become separated from trash cans due to numerous factors. For example, animal interference or inclement weather may provide conditions under which a trash can lid may become separated from a trash can.

Animal interference, such as by raccoons, may result in large messes and time-consuming labor to clean up these messes. Furthermore, heavy winds may blow the contents of a trash can large distances away from the trash can, creating additional problems for an individual. Cleaning up refuse is not only time consuming but may also be frustrating or difficult. Particularly, individuals suffering from physical ailments may struggle to clean up the aftermath of a tipped garbage can. Therefore, there is a need in the prior art for an effective trash can lid fastener that is both easy to use and adjustable to adapt to various sizes and configurations of garbage cans.

### SUMMARY OF THE INVENTION

In view of the foregoing disadvantages inherent in the known types of trash can lid security devices now present in the prior art, the present invention provides a trash can lid fastener wherein the same can be utilized for providing convenience for the user when securing a trash can lid in a closed position.

The present system comprises a bracket having a first arm and a second arm. The second arm is orthogonally affixed to the first arm at an end of the first arm. A plurality of apertures is disposed through the first arm. The plurality of apertures is configured to secure the first arm to a first targeted surface via a first arm fastener. A shoulder is perpendicularly disposed upon a contact surface of the second arm. The shoulder is slidably engaged within a slot. At least one second arm fastener extends through the slot and is in operable connection with the shoulder. As such, engagement of the second arm fastener allows for adjustability of the second arm fastener along the a lot.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a bottom-up perspective view of an embodiment of the trash can lid fastener.

FIG. 2 shows a top-down perspective view of an embodiment of the trash can lid fastener.

FIG. 3 shows a side view of an embodiment of the trash can lid fastener.

FIG. 4 shows a cross-sectional side view of an embodiment of the trash can lid fastener in use upon a trash can.

### DETAILED DESCRIPTION OF THE INVENTION

Reference is made herein to the attached drawings. Like reference numerals are used throughout the drawings to depict like or similar elements of the trash can lid fastener. The figures are intended for representative purposes only and should not be considered to be limiting in any respect.

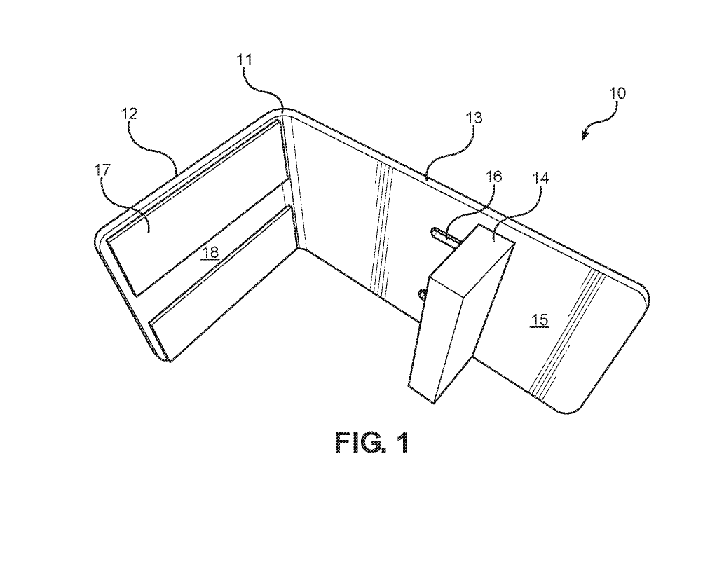

Referring now to FIG. 1, there is shown a bottom-up perspective view of an embodiment of the trash can lid fastener. The trash can lid fastener 10 comprises a bracket 11. The bracket 11 is defined by a first arm 12 and a second arm 13. The second arm 13 is orthogonally affixed to an end of the first arm 12. In the illustrated embodiment, the bracket 11 is L-shaped, such that the bracket 11 will contour a top end of a trash can to engage both a side wall of the trash can and a top surface of a lid of a trash can. In one embodiment, the bracket 11 is made of a durable material, such that its shape is preserved when mounted upon a trash can.

A shoulder 14 is perpendicularly disposed on a contact surface 15 of the second arm 13. The shoulder 14 is slidably engaged within at least one slot 16. In the illustrated embodiment, a pair of slots 16 are provided, wherein each slot of the pair of slots 16 is parallel to the other slot. In one embodiment, the slot 16 is linearly oriented along the second arm 13, such that the slot 16 runs parallel to an edge of the second arm 13. In one embodiment, the shoulder 14 is made of a relatively soft material, relative to the bracket 11, such that the shoulder 14 can be shaped in response to being pressured upon a surface, such as a trash can lid.

In one embodiment, at least one pad 17 is disposed on a lower surface 18 of the first arm 12. The pad 17 is configured to rest flush against a side wall of a trash can. When the pad 17 rests flush against the side wall of the trash can, less damage is exerted upon the side wall than would be in the absence of the pad 17. In the illustrated embodiment, a pair of pads 17 are disposed on the lower surface of the first arm. The pair of pads 17 are rectangular in configuration and are disposed in a linearly parallel manner.

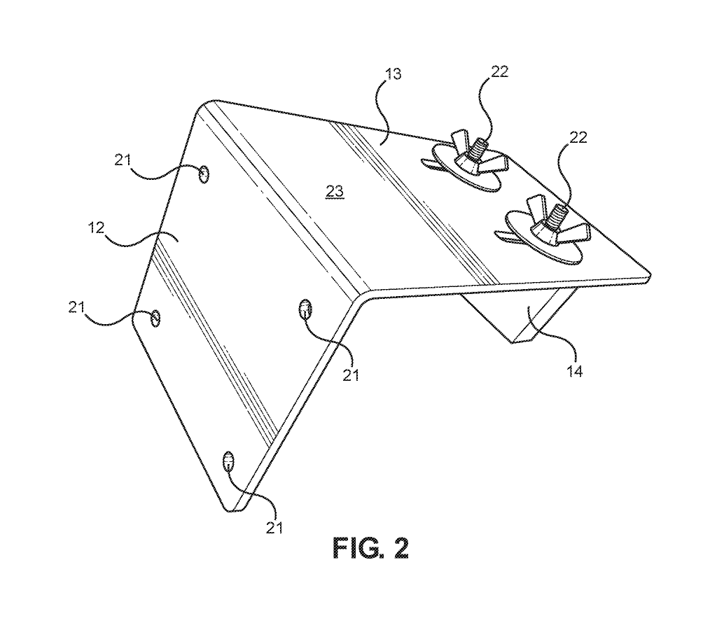

Referring now to FIG. 2, there is shown a top-down perspective view of an embodiment of the trash can lid fastener. A plurality of apertures 21 are disposed through the first arm 12. The plurality of apertures 21 is configured to secure the first arm 12 to a targeted surface via a first arm fastener. The first arm fastener is any fastener suitable for securing the first arm to the targeted surface, such as a threaded screw, an adhesive or a nail.

At least one second arm fastener 22 extends through the slot and is in operable connection with the shoulder 14. The second arm fasteners 22 are engageable from a top surface 23 of the second arm 13. The second arm fasteners 22 are configured to be freely adjustable, such that once the first arm 12 is secured to the side wall of a trash can, the second arm fasteners 22 provide sufficient adjustability to adapt to variable sizes and dimensions of trash can lids.

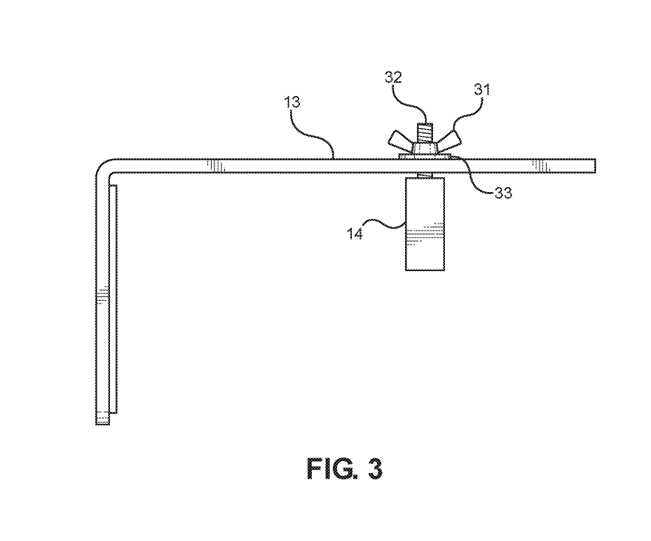

Referring now to FIG. 3, there is shown FIG. 3 shows a side view of an embodiment of the trash can lid fastener. In the illustrated embodiment, the second arm fastener comprises a wing nut 31. The wing nut 31 is in operable connection with a threaded rod 32. The threaded rod 32 is affixed to a top surface of the shoulder 14. As such, engagement of the wing nut 31 will increase or decrease the length of the threaded rod 32 between the shoulder 14 and the second arm 13, such that the shoulder 14 can be placed into a position flush upon a trash can lid.

In an alternate embodiment, the trash can lid fastener 10 further comprises a washer 33 disposed between the wing nut 31 and the top surface of the second arm 13. The washer 33 is annular and is engaged around the threaded rod 32. The washer 33 provides convenience to the user, as it prevents damage from being made upon the top surface of the second arm, such as through overtightening of the wing nut 31 upon the threaded rod 32.

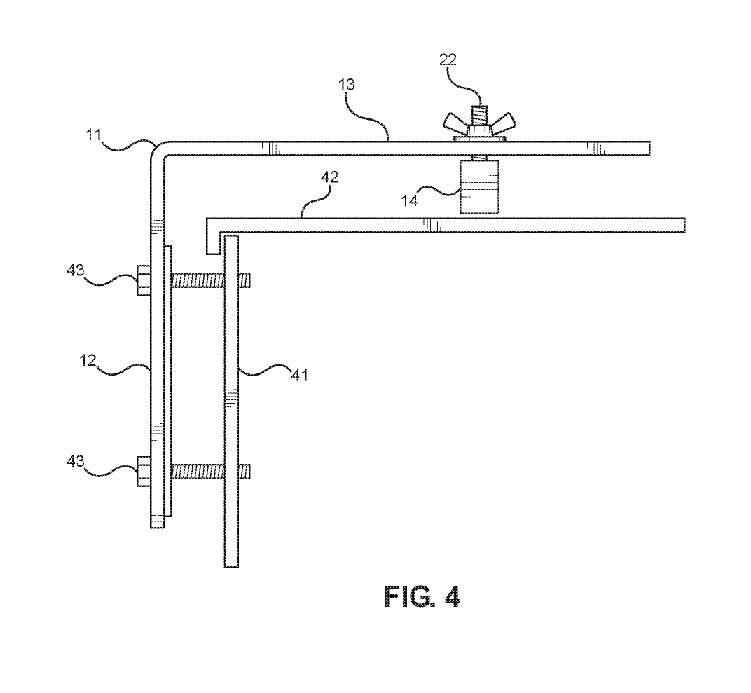

Referring now to FIG. 4, there is shown a cross-sectional side view of an embodiment of the trash can lid fastener in use upon a trash can. In use, the bracket 11 is first placed upon a trash can 41 and a trash can lid 42. The bracket 11 is dimensioned such that the second arm 13 extends over the trash can lid 42 and the first arm 12 extends over a side portion of the trash can 41.

The first arm 12 is secured to the side portion of the trash can 41 via the first arm fastener 43. In the illustrated embodiment, the first arm fastener 43 is a plurality of screws, however any suitable fastener for securing the first arm 12 to the side portion of the trash can 41 may be utilized. The shoulder 14 is placed into a position flush against a top surface of the trash can lid 42 where the trash can lid 42 is engaged upon the trash can 41. Specifically, engagement of the second arm fastener 22 is configured to orient the shoulder 14 into the position flush against the top surface of the trash can lid 42.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trash can lid fastener, comprising:
a bracket having a first arm and a second arm;
wherein the second arm is orthogonally affixed to the first arm at an end thereof;
a plurality of apertures is disposed through the first arm;
wherein the plurality of apertures is configured to secure the first arm to a first targeted surface via a first arm fastener;
a shoulder perpendicularly disposed on a contact surface of the second arm;
the shoulder slidably engaged within a slot;
at least one second arm fastener extending through the slot in operable connection with the shoulder, such that engagement of the second arm fastener enables adjustability along the slot.

2) The trash can lid fastener of claim 1, further comprising at least one pad disposed on a lower side of the first arm.

3) The trash can lid fastener of claim 1, wherein the slot is longitudinally disposed along the second arm, such that the slot runs parallel to an edge of the second arm.

4) The trash can lid fastener of claim 1, wherein the second arm fastener comprises a wing nut in operable connection with a threaded rod mounted upon the shoulder.

5) The trash can lid fastener of claim 4, further comprising a washer disposed between the wing nut and an upper surface of the second arm.

6) A trash can lid fastener, comprising:
a bracket having a first arm and a second arm;
wherein the second arm is orthogonally affixed to the first arm at an end thereof;
a plurality of apertures disposed through the first arm;
at least one pad disposed on a lower side of the first arm;
wherein the plurality of apertures is configured to secure the first arm to a first targeted surface via a first arm fastener;
a shoulder perpendicularly disposed on a contact surface of the second arm;
the shoulder slidably engaged within a slot;
at least one second arm fastener extending through the slot in operable connection with the shoulder, such that engagement of the second arm fastener enables adjustability along the slot.
wherein the second arm fastener comprises a wing nut in operable connection with a threaded rod mounted upon the shoulder.

7) The trash can lid fastener of claim 6, further comprising a washer disposed between the wing nut and an upper surface of the second arm.

8) A method of securing a trash can lid in a closed position, comprising:
placing a bracket having a first arm and a second arm upon a top end of a trash can;
wherein the second arm is orthogonally affixed to the first arm at an end thereof;
a plurality of apertures is disposed through the first arm;
a shoulder perpendicularly disposed on a contact surface of the second arm;
the shoulder slidably engaged within a slot;
at least one second arm fastener extending through the slot in operable connection with the shoulder, such that engagement of the second arm fastener enables adjustability along the slot;
securing the first arm to a side portion of a trash can via the first arm fastener;
placing the shoulder into a position flush against a trash can lid via actuation of the second arm fastener.
